(19) United States
(12) Patent Application Publication
(10) Pub. No.: US 2025/0215620 A1
(43) Pub. Date: Jul. 3, 2025

(54) WOVEN VERTICAL CURTAIN FABRIC

(71) Applicant: Berteks Tekstil Sanayi Ve Ticaret Anonim Sirketi, Osmangazi (TR)

(72) Inventor: Burcu ERDEBIL, Osmangazi (TR)

(21) Appl. No.: 18/598,542

(22) Filed: Mar. 7, 2024

(30) Foreign Application Priority Data
Dec. 29, 2023 (TR) 2023/019746

(51) Int. Cl. D03D 13/00; A47H 23/10; D03D 1/00; D03D 15/283

(52) U.S. Cl. CPC D03D 13/008; A47H 23/10; D03D 1/00; D03D 15/283; D10B 2331/04; D10B 2401/22; D10B 2503/02

(57) ABSTRACT

Disclosed a new vertical curtain fabric woven as a whole, containing tulle and sunshade in a monolithic structure, developed to reduce the effect of sunlight, to protect from the harmful effects of UV rays and to ensure the privacy of private life in indoors such as home, hotel, workplace etc., In particular, disclosed is a stable vertical curtain fabric that maintains its form, in which bending and wrinkling is prevented by applying thermosetting yarn and heat treatment, and to a method for obtaining it.

### CROSS-REFERENCE TO RELATED APPLICATIONS

Not applicable.

### BACKGROUND OF THE INVENTION

### Technical Field

The invention relates to a new vertical curtain fabric woven as a whole, containing tulle and sunshade in a monolithic structure, developed to reduce the effect of sunlight, to protect from the harmful effects of UV rays and to ensure the privacy of private life in indoors such as home, hotel, workplace etc.

The invention particularly relates to a stable vertical curtain fabric that maintains its form, in which bending and wrinkling is prevented by applying thermosetting yarn and heat treatment, and to a method for obtaining it.

### State of the Art

Curtain fabrics are decorative products produced with a wide variety of fabrics and weaving techniques and positioned vertically on the base used for curtain purposes. Curtains are used to adjust the light sources coming into the interior spaces and/or to protect the private lives of the people living in the used space. Today, with the changing perception of fashion and technology, curtain structures are also changing. In this context, curtains are made visually fashionable as well as functional.

In the state of art, the use of tulle curtains also brings along a background curtain called sunshade. The problem of needing a second curtain fabric in the use of tulle curtains has not been solved. Another situation is that the curtains are used vertically and when you want to go behind the curtain, the curtain must be pulled completely to the right or left.

Unlike the mechanical curtain types known in the present art, the new curtain systems produced are vertical curtains. These curtains are a type of curtains with mechanism in which PVC or fabric strips of different colors and patterns are arranged side by side longitudinally. These curtain systems have different models as tulle curtains, fabric curtains, PVC curtains and aluminum curtains. Knitted (raschel) production method is used in the production of these curtains. In vertical curtain systems produced with this knitting (raschel) production method, the needles used in production cause pinhole problems and therefore light leaks occur in these areas. In addition, in the fabrics produced with this method, the yarns inside the fabric must be pulled during the separation process. These yarns are difficult to pull and also cause loss of time in production because they break frequently.

As a result of the research carried out in the literature on the subject, application numbered TR 2018/05766 was found. The application relates to vertical zebra curtain fabric used in all interior spaces, including residences and workplaces. The said fabric comprises vertical stripes with a double-sided knitted velvet surface and a tulle or mesh surface that forms the transparent part. However, in the mentioned document, there is no mention of a vertical curtain structure woven monolithically from woven fabrics.

As a result of the research carried out in the literature on the subject, a utility model application numbered TR 2019/02531 was found. The application relates to wooden vertical curtain structures used in places where curtains are needed such as homes, offices and workplaces. Said curtain structure comprises more than one wooden curtain module positioned vertically, parallel to each other, and a wagon positioned on at least one case to enable the movement of said wooden curtain module around itself and in the x direction. However, in the mentioned document, there is no mention of the vertical curtain structure, which includes tulle and sunshades on the same mechanism and is woven from woven fabrics.

As a result, due to the above-mentioned drawbacks and the inadequacy of the existing solutions, it has become necessary to make a development in the relevant technical field.

### SUMMARY OF THE INVENTION

The invention aims to solve the above-mentioned drawbacks, inspired by current situations.

The main object of the invention is to present a vertical curtain fabric and its production method obtained by weaving method that includes tulle and sunshade on the same mechanism. With this weaving method, light leaks caused by the knitting method in the present art will be prevented.

The object of the invention is to provide a vertical curtain structure that comprises a vertical curtain sunshade section that prevents the sunlight coming from outside and the view of the inside from the outside with its three-layered structure, and vertical curtain tulle section that allows the sun rays from the outside to be let in with a single-layer structure.

An object of the invention is to provide ease of use by allowing the fabric section comprising the sunshade-tulle-sunshade combination to be independent from each other and to pass between them without moving them to the right or left.

Another object of the invention is to provide the weaving of fabrics with the same properties by the weaving method as an alternative to the curtains produced by the knitting method.

Another object of the invention is to ensure that the vertical curtain sunshade section and the vertical curtain tulle section are brought to a certain hardness by using thermosetting yarns as warp and/or weft and hardening by the fixation process (heat). The forces (grammages) of the vertical curtain sunshade section and the vertical curtain tulle section need to be of a certain weight and hardness. Vertical curtain fabrics that do not have the appropriate weight and hardness cause fitting failures, especially in the lower areas. Undesired collapses are observed in the tulle areas of the vertical curtain fabric. The object of the invention is to obtain a vertical curtain fabric that stands flat when attached to the mechanism, by using thermosetting yarns and the fixation process.

Another object of the invention is to prevent yarn breaks, edge pilling and loss of time in production by ensuring that the reports are properly separated from each other in the woven fabric structure.

Another object of the invention is to provide a product comprising two separate control mechanisms to control the tulle and the sunshade. One of the control mechanisms rotates the vertical curtain segments around its own axis to provide light control. Thus, when it is wanted to benefit from sunlight, the tulle part of the curtain fabric is used, and when privacy is desired, the sunshade (background) part of the curtain fabric is used by moving the mechanism. The other control mechanism moves the curtain to the right, left or middle to ensure that it is fully open or fully closed.

Another object of the invention is to eliminate the garment industry step in the production of pleated curtains and to give the appearance of pleats with their own tulle and sunshade sections.

In order to fulfill the objects described above, the invention is a vertical curtain fabric and comprising the following:
Vertical curtain sunshade section with a 3-layered structure, which prevents the inside from being seen from the outside and the sunlight from penetrating inside, which is woven using knits with weft yarns and warp yarns comprising combinations of normal yarn and thermosetting (melting) yarn,
A vertical curtain tulle section with a single-layered structure, located between two vertical curtain sunshade sections, allowing the sunlight to let be in, which is woven using knits with weft threads and warp yarns, comprising combinations of normal yarns and thermosetting (melting) yarns.

In order to fulfill the objects described above, the invention is a method for obtaining vertical curtain fabric and comprises the following process steps;
i. Simultaneous weaving of a 3-layer vertical curtain sunshade section (1) and a single-layer vertical curtain tulle section (2) by using knitting with weft and warp yarns containing normal yarn and thermosetting (melting) yarn combinations, such that the vertical curtain tulle section (2) form a repeat between two vertical curtain sunshade sections (1),
ii. The appropriate pre-treatment processes of the woven fabric,
iii. Obtaining a stable fabric structure that maintains its form by fixing the woven fabric with heat treatment in the finishing process,
iv. Separation of the fabric formed with the mentioned repeats into band structure.

The structural and characteristic features and all the advantages of the invention will be more clearly understood by means of the drawing given below and the detailed description written with reference to this drawing, and therefore the evaluation needs to be made by taking this drawing and detailed description into consideration.

### BRIEF DESCRIPTION OF DRAWINGS

FIG. 1 is a repeat view of the vertical curtain fabric, which is the subject of the invention.

FIG. 2 is a 3D image of vertical curtain fabric, which is subject of the invention.

FIG. 3 is an open view of the vertical curtain fabric, which is subject of the invention, attached to the mechanism.

FIG. 4 is a bird's eye view of the vertical curtain fabric, which is subject of the invention, in the open state attached to the mechanism.

FIG. 5 is a sample knits structure view of the vertical curtain fabric, which is subject of the invention.

### DESCRIPTION OF PIECE REFERENCES

1. Vertical curtain sunshade section
1.1. Upper layer fabric structure
1.2. Lower layer fabric structure
2. Vertical curtain tulle section
3. Clips
C1: First warp yarn
C2: Second upper warp yarn
C3: Second lower warp yarn
A: Weft yarns

### DETAILED DESCRIPTION OF THE INVENTION

In this detailed description, the vertical curtain fabric, which is the subject of the invention and the method for obtaining it are described only for a better understanding of the subject.

The invention relates to a vertical curtain fabric that is woven as a whole, with tulle and sunshade in a monolithic structure, and its production method. The vertical curtain fabric, which is subject of the invention comprises 3-layered vertical curtain sunshade section (1) which prevents the inside from being seen from the outside and from letting in sunlight, which is woven using knits with weft yarns and warp yarns, comprising combinations of normal yarn and thermosetting (melting) yarn, and a single-layered vertical curtain tulle section (2) located between two vertical curtain sunshade sections (1), which is woven using knits with weft yarns and warp yarns, comprising combinations of normal yarns and thermosetting (melting) yarns, that allowing the sun rays to be let in.

An embodiment of the curtain fabric, which is subject of the invention comprises at least two vertical curtain sunshade sections (1) in a 3-layered structure consisting of the upper layer fabric structure (1.1), woven with the second upper warp yarns and weft yarns, middle layer fabric structure woven with first warp yarn and weft yarn, the lower layer fabric structure (1.2) woven with the second lower warp yarn and weft yarn and a vertical curtain tulle section (2) in a single-layered structure woven with the first warp yarn and weft yarn. The vertical curtain tulle section (2) mentioned here form middle layer fabric structure of the vertical curtain sunshade section (1).

The said thermosetting yarn is preferably melting polyester yarn.

The mentioned normal yarn and the melting yarn, including but not limited to these, are selected from polyester and/or blended polyester (natural and/or synthetic fiber) yarns with a yarn count between 10 denier and 10000 denier. While the yarns can be used normally, they can also be used by twisting, folding, or combining them with each other.

The said vertical curtain tulle section (2) is woven with warp and weft yarns comprising normal yarn and preferably thermosetting yarn in ranges between 10-20%, and thus it remains stable and maintains its form, wrinkling, bending, etc. problems are prevented.

The said vertical curtain sunshade section (1) maintains its stable form by being woven with warp yarns and weft yarns comprising normal yarn and preferably thermosetting yarn in ranges between 3-10%.

Thwing-Albert's Handle-O-Meter (HOM) hardness value of the vertical curtain tulle section (2) in the product, which is subject of the invention is approximately half of the hardness value of the vertical curtain sunshade section (1).

The weight ratio of the vertical curtain tulle section (2) to the vertical curtain sunshade section (1) in the product, which is subject of the invention is preferably 1:3.

The warp density of said vertical curtain sunshade section (1) is preferably 45 wires/cm, and the warp density of the vertical curtain tulle section (2) is preferably 15 wires/cm.

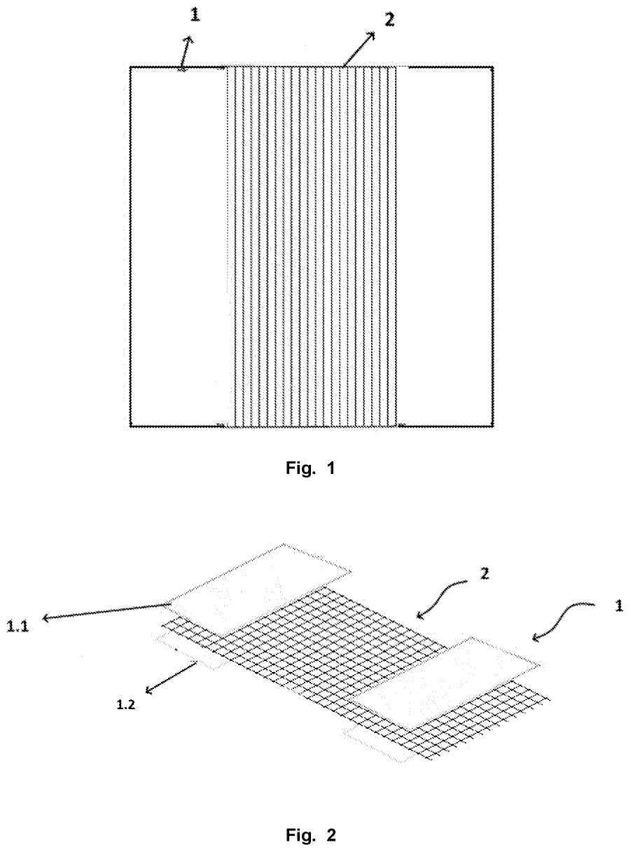

The vertical curtain tulle section (2) in the product, which is subject of the invention is preferably in the range of 10-20 cm, and the vertical curtain sunshade section (1) is in the range of 10-15 cm and is located on both sides of the vertical curtain tulle section (2). In FIG. 1, it is given the repeat image of the vertical curtain fabric, which is the subject of the invention.

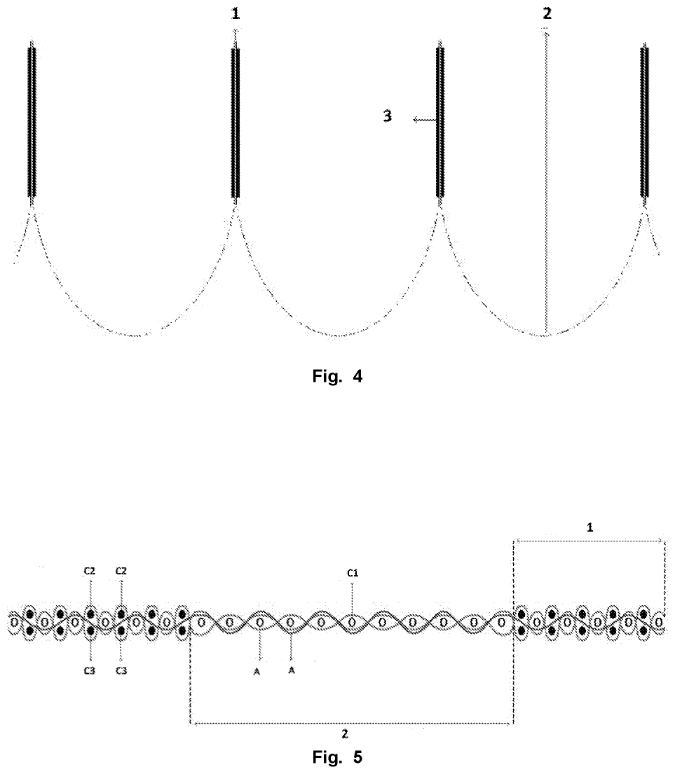

The vertical curtain system to be formed with vertical curtain fabric (FIG. 4) comprises the vertical curtain sunshade section (1), the vertical curtain tulle section (2) and the curtain clips (3) that enable the vertical curtain sunshade sections to move. In the fabric structure that forms the vertical curtain system, the vertical curtain sunshade section (1) and the vertical curtain tulle section (2) are designed and woven in a row, in order to be integrated with each other. The fabric is ensured to lie flat downwards without comprising any underweight or supporting material, and it is ensured that it appears as a continuation of each other in the direction of the given movement with the designed knitting structure. In the knits structure designed here, single-layered knits structures are used in the vertical curtain tulle section (2), while 3-layered knits structures with connections between layers are used in the vertical curtain sunshade section (1).

In the vertical curtain mechanism, the curtain sections rotate around their own axis for light control, and when it is desired to gather the curtain, it can be moved left, right or in the middle. With the vertical curtain fabric of the invention, when the vertical curtain is open, the tulle function is exhibited by means of the vertical curtain tulle section (2) and it is possible to benefit from sunlight (FIG. 3). When the mechanism is moved, the vertical curtain sunshade sections (1) also move, so all the fabric sections overlap and exhibit the sunshade function. In the vertical curtain system, when the mechanism is open, the vertical curtain sunshade sections (1) attached by clips (3) have a tense and flat form, and the vertical curtain tulle sections (2) have an oval appearance (FIG. 4). Two vertical curtain sunshade sections (1) are attached to the curtain clips (3) used in the vertical curtain mechanism. Thus, when the mechanism moves, all the fabric sections overlap each other and act as if they were a single piece. The mentioned curtain clips (3) are the basic part of the mechanism that is located at the top of the vertical curtain, has a rectangular form and gives movement to the curtain. This curtain clip (3) is formed by the interlocking of the clip front cover and the clip rear cover. Both pieces have a jagged surface (hackly) to compress more than one fabric. Additionally, there is a clip mounting hanger on the rear cover of the clip to enable the mounting of the vertical curtain to the cornice. Said vertical curtain clips (3) are connected to the vertical curtain sunshade sections (1) on one side, and are connected to the cornice with a mounting hanger on the other side. When you want to switch to tulle or sunshade mode by operating the mechanism, the vertical curtain sunshade sections (1) can perform rotation movement by means of the clips (3).

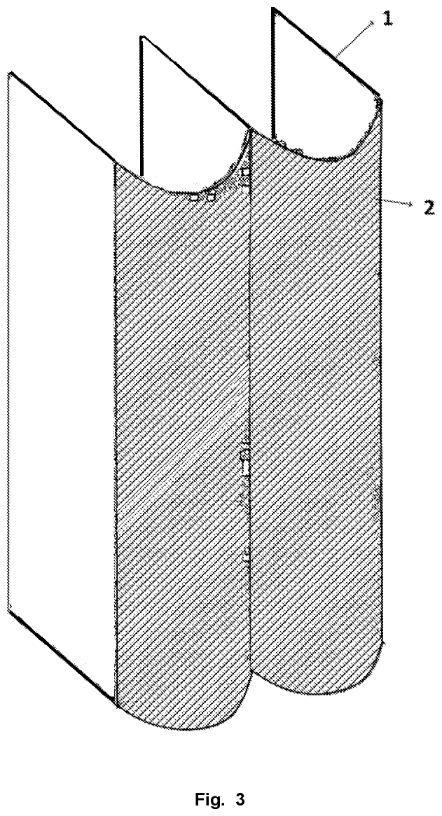

As shown in FIG. 2, the vertical curtain sunshade section (1) consists of 3 layers at the weaving stage; upper layer fabric structure (1.1), middle layer fabric structure and lower layer fabric structure (1.2) and the vertical curtain tulle section (2) consists of a single layer. Double beam warp is preferably used to form the curtain fabric of the invention. However, if necessary, the warp can be unraveled in more beams and put on the loom. In order to make the woven vertical curtain to maintain its form and function properly within the mechanism, melting yarn, known as thermosetting yarn, is preferably used in one of the warp beams. For this reason, the warp yarn used are grouped so that each layer is woven with a different warp yarn. The first warp yarn (C1) and the weft yarns (A) are used together to form the vertical curtain tulle section (2). At the same time, this fabric structure forms the middle layer fabric structure of the vertical curtain sunshade section (1). In the vertical curtain sunshade section (1), the second upper warp yarn (C2) and weft yarn (A) are woven together to form the upper layer fabric structure. In the vertical curtain sunshade section (1), the second lower warp yarn (C3) and the weft yarn (A) are woven together to form the lower layer fabric structure. The upper layer fabric structure (1.1) and the lower layer fabric structure (1.2) can be woven in a similar knit or in a different knit structure. An example knitting structure of vertical curtain fabric structure is given in FIG. 5.

In an example of the curtain fabric, which is the subject of the invention, the first warp yarn (C1) is used in the vertical curtain tulle section (2) and in the middle layer of the vertical curtain sunshade section (1). The first warp yarn (C1) consists of combining polyester yarn with a thermosetting yarn called melting yarn to ensure that the fabric stands flat. With this yarn, the fabric is hardened with heat after the fixation process, bringing the vertical curtain sunshade section (1) and the vertical curtain tulle section (2) to a certain hardness. In the designed fabric structure, the forces (grammages) of the vertical curtain sunshade section (1) and the vertical curtain tulle section (2) need to be of a certain weight and hardness. Vertical curtain fabrics that do not have the appropriate weight and hardness cause fitting failures, especially in the lower areas. Unwanted collapses are observed in the tulle areas of the vertical curtain fabric. With the fabric structure, which is subject of the invention, it is guaranteed that the vertical curtain fabric will stand flat when attached to the mechanism.

A method for obtaining the vertical curtain fabric of the invention comprises the following process steps:
i. Simultaneous weaving of a 3-layer vertical curtain sunshade section (1) and a single-layer vertical curtain tulle section (2) by using knit with weft and warp yarns containing normal yarn and thermosetting (melting) yarn combinations which the vertical curtain tulle section (2) form a repeat between two vertical curtain sunshade sections (1),
ii. The appropriate pre-treatment processes of the woven fabric,
iii. Obtaining a stable fabric structure that maintains its form by fixing the woven fabric with heat treatment in the finishing process,
iv. Separation of the fabric formed with the mentioned repeats into band structure.

In the process step (i) of the method, which is subject of the invention, a 3-layer vertical curtain sunshade section (1) is woven by using knits as the upper layer fabric structure (1.1) with the second upper warp yarn and weft yarns, the middle layer fabric structure with the first warp yarn and weft yarns, and the lower layer fabric structure (1.2) with the second lower warp yarn and weft yarns (1.2). The vertical curtain tulle section (2) in a single-layer structure is woven by using knitting with the first warp yarn and weft yarns. The said warp and weft yarns preferably comprise thermosetting (melting) yarn.

In a preferred embodiment of the method, which is subject of the invention, a vertical curtain sunshade section (1) is woven by using the first warp yarn (C1), the second upper warp yarn (C2), the second lower warp yarn (C3) and weft yarns (A). The first warp yarn (C1) is a special yarn, preferably consisting of combining melting polyester yarn or normal polyester yarn with a thermosetting yarn called melting yarn. Normal polyester yarn is preferably used as the second upper warp yarn (C2) and second lower warp yarn (C3), but depending on the construction, thermosetting yarn can also be used. Normal polyester yarn is preferably used as weft yarn, but depending on the construction, thermosetting yarn can also be used.

In a preferred embodiment of the method of the invention, the vertical curtain tulle section (2) is woven using a special yarn, preferably a melting polyester yarn or a special yarn formed by combining normal polyester yarn and a thermosetting yarn called melting yarn as warp yarn and normal polyester yarn as the weft yarn, however, depending on the construction, thermosetting yarn can also be used.

In the vertical curtain fabric, which is subject of the invention, yarn comprising 25-35% thermosetting material is used as warp and/or weft, and a thermosetting yarn ratio of 5-10% is used throughout the fabric. In the finishing process of the vertical curtain fabric woven as a whole on the weaving machine, the single-layer vertical curtain tulle section (2) and the three-layer vertical curtain sunshade section (1) are fixed at a temperature of 150-210° C., allowing different fabric hardness to be obtained. In this way, a smooth curtain structure is obtained that is stable in use in the form of a band and does not show wrinkling or bending behavior.

Thermosetting yarns have the ability to melt between 150-210° C. While melting does not occur below 150° C., the structure of the yarn ossifies above 210° C. and loses its flexibility. The hardening of the thermosetting yarn is determined by heat fix between 150-210° C. The hardening rate of this yarn increases as it approaches the upper limit. In each vertical curtain fabric made, the optimum fixation degree was determined by looking at the material content of the thermosetting yarn and the melting yarn rate in the total fabric construction.

The vertical curtain fabric whose weaving process is completed is formed with a specific repeat as shown in FIG. 1 and must be separated from these repeats. There are more than one repeat sections in the fabric depending on the weaving width. The separation process is carried out equally between the vertical curtain sunshade sections of the two repeats.

The vertical curtain fabric, which is the subject of the invention can be produced by coloring it with fabric dye and/or yarn dye.

In line with the demand that the vertical curtain fabric of the invention provide different light transmittances, warp and weft frequencies can be adjusted according to the knitting structure used in order to control the light transmittance in the vertical curtain sunshade section (1) and vertical curtain tulle section (2). Thus, fabric structures with high or low light transmittance can be formed according to demand. Preferably, the optimum construction is formed by making the warp density of the vertical curtain tulle section 15 wires/cm and the warp density of the vertical curtain sunshade section 45 wires/cm.

1. A vertical curtain fabric comprising:
a vertical curtain sunshade section with a 3-layered structure, which prevents the inside from being seen from the outside and the sunlight from penetrating inside, which is woven using knits with weft yarns and warp yarns comprising combinations of normal yarn and thermosetting (melting) yarn;
a vertical curtain tulle section with a single-layered structure, located between two vertical curtain sunshade sections, allowing the sunlight to be let in, which is woven using knits with weft threads and warp yarns, comprising combinations of normal yarns and thermosetting (melting) yarns.

2. The curtain fabric according to claim 1, wherein the at least two vertical curtain sunshade sections are provided in a 3-layered structure comprising an upper layer fabric structure woven with the second upper warp yarn and weft yarns, a middle layer fabric structure woven with the first warp yarn and weft yarns, and a lower layer fabric structure woven with the second lower warp yarn and weft yarn.

3. The curtain fabric according to claim 1, wherein the vertical curtain sunshade sections maintain its stable form by weaving with warp yarn and weft yarns comprising thermosetting yarn between 3-10%.

4. The curtain fabric according to claim 1, wherein the vertical curtain tulle section is a single-layered structure woven with the first warp yarn and weft yarns.

5. The curtain fabric according to claim 1, wherein the vertical curtain tulle section maintains its stable form by weaving with warp yarn and weft yarns comprising 10-20% thermosetting yarn.

6. The curtain fabric according to claim 1, wherein the said thermosetting yarn is a melting polyester yarn.

7. The curtain fabric according to claim 1, wherein; the said normal yarn and the melting yarn, including but not limited to, are selected from polyester and/or blended polyester (natural and/or synthetic fiber) yarns, with a yarn count between 10 denier and 10000 denier.

8. The curtain fabric according to claim 1, wherein a Handle-O-Meter (HOM) hardness value of the vertical curtain tulle section is half of a hardness value of the vertical curtain sunshade section.

9. The curtain fabric according to claim 1, wherein a weight ratio of the vertical curtain tulle section and the vertical curtain sunshade section is 1:3.

10. The curtain fabric according to claim 1, wherein a warp density of the vertical curtain sunshade section is 45 wires/cm.

11. The curtain fabric according to claim 1, wherein a warp density of the vertical curtain tulle section is 15 wires/cm.

12. A method to obtain a vertical curtain fabric, comprising the following process steps:
simultaneous weaving of a 3-layer vertical curtain sunshade section and a single-layer vertical curtain tulle section by using knits with weft and warp yarns comprise normal yarn and thermosetting (melting) yarn combinations, such that the vertical curtain tulle section forms a repeat between two vertical curtain sunshade sections;
pre-treatment processes of the woven fabric;
obtaining a stable fabric structure that maintains its form by fixing the woven fabric with heat treatment in the finishing process;
separation of the fabric formed with the mentioned repeats into band structure.

13. The method according to claim 12, wherein in the process step i), the vertical curtain sunshade section with 3-layered structure is woven by using 3-layered knits structures with connections between layers as the upper layer fabric structure with second top warp yarn and weft yarns, the middle layer fabric structure with the first warp yarn and weft yarns, the lower layer fabric structure with the second lower warp yarn and weft yarns.

14. The method according to claim 13, wherein in the process step i), the vertical curtain sunshade section is woven by using the melting polyester yarn and normal polyester yarn as the second upper warp yarn, the first warp yarn and the second lower warp yarn, and the melting polyester yarn and normal polyester yarn as the weft yarn.

15. The method according to claim 12, wherein in the process step i), the single-layered vertical curtain tulle section is woven by using the single-layered knits structures of the first warp yarn and weft yarns.

16. The method according to claim 15, wherein in the process step i), the vertical curtain tulle section is woven by using the melting polyester yarn and normal polyester yarn as the warp and weft yarn.

17. The method according to claim 12, wherein after the process step ii), coloring processes are applied with a fabric dye for coloring to the woven fabric.

18. The method according to claim 12, wherein in the process step iii), the woven fabric is fixed at a temperature range of 150-210° C. in a finishing process.
